(19) United States
(12) Patent Application Publication
(10) Pub. No.: US 2022/0245864 A1
(43) Pub. Date: Aug. 4, 2022

(54) GENERATING METHOD OF CONFERENCE IMAGE AND IMAGE CONFERENCE SYSTEM

(71) Applicants: Yi-Ching Tu, Taipei City (TW); Po-Chun Liu, Taipei City (TW); Kai-Yu Lei, Taipei City (TW); Dai-Yun Tsai, Taipei City (TW)

(72) Inventors: Yi-Ching Tu, Taipei City (TW); Po-Chun Liu, Taipei City (TW); Kai-Yu Lei, Taipei City (TW); Dai-Yun Tsai, Taipei City (TW)

(73) Assignee: COMPAL ELECTRONICS, INC., Taipei City (TW)

(21) Appl. No.: 17/586,714

(22) Filed: Jan. 27, 2022

Related U.S. Application Data
(60) Provisional application No. 63/145,491, filed on Feb. 4, 2021.

(51) Int. Cl. G06T 11/00; G06T 7/20; G06T 7/73; G06V 40/10; H04N 5/265

(52) U.S. Cl. CPC G06T 11/00; G06T 7/20; G06T 7/73; H04L 65/403; H04N 5/265; G06T 2207/30196; G06V 40/10

(57) ABSTRACT

A generating method of conference image and an image conference system are provided. In the method, a user and one or more tags in a captured actual image are identified. The moving behavior of the user is tracked, and the position of the viewing range in the actual image is adjusted according to the moving behavior. The virtual image corresponding to the tag is synthesized according to the position relation between the user and the tag, to generate a conference image.

### CROSS-REFERENCE TO RELATED APPLICATION

This application claims the priority benefit of U.S. provisional application Ser. No. 63/145,491, filed on Feb. 4, 2021. The entirety of the above-mentioned patent application is hereby incorporated by reference herein and made a part of specification.

### BACKGROUND

### Technical Field

The disclosure relates to an image conference technology, and in particular to a generating method of conference image and an image conference system.

### Description of Related Art

Teleconferencing allows people in different locations or spaces to have conversations, and conference-related equipment, protocols and/or applications are also quite mature. It is worth noting that today's long-distance video will be accompanied by virtual and real interactive content. In practical applications, the presenter may move in the real space, but the virtual synthetization result cannot be viewed on the screen in real time, and it is necessary to rely on others to give instructions or to assist the presenter's action or operating position.

### SUMMARY

In view of this, the embodiments of the present invention provide a generating method of a conference image and an image conference system, which can adaptively adjust the state of the virtual image.

The image conference system of the embodiment of the present invention includes an image capture device and a computing device (but is not limited to). The image capture device is configured to capture an image. The computing device is coupled to the image capture device. The computing device is configured to perform the following steps: identify a user and at least one tags in an actual image captured by the image capture device; track a moving behavior of the user, and adjust the position of a viewing range in the actual image according to the moving behavior; and synthesize a virtual image corresponding to the at least one tags in the viewing range in the actual image according to a position relation between the user and the at least one tags, to generate a conference image.

The generating method of a conference image of the embodiment of the present invention includes the following steps (but is not limited to): identifying a user and at least one tags in a captured actual image; tracking a moving behavior of the user, and adjusting a position of a viewing range in the actual image according to the moving behavior; and synthesizing a virtual image corresponding to the at least one tags in the viewing range in the actual image according to a position relation between the user and the at least one tags, to generate a conference image.

Based on the above, according to the image conference system and the generating method of the conference image of the embodiments of the present invention, wherein the content, position, size, range or other restrictions of the virtual image are determined through the tags and the corresponding virtual images are provided according to the user's position. In this way, the presenter can know the limitations of the virtual image without having to display it on the screen, and can even change the state of the virtual image by interacting with the tags.

In order to make the above-mentioned features and advantages of the present application more obvious and easier to understand, the following specific examples are given, and are described in detail as follows in conjunction with the accompanying drawings.

### BRIEF DESCRIPTION OF THE DRAWINGS

FIG. 1 is a schematic diagram of an image conference system according to an embodiment of the present invention.

FIG. 2 is a flowchart of a generating method of a conference image according to an embodiment of the present invention.

FIG. 3 is a flowchart of identifying a position relation according to an embodiment of the present invention.

FIG. 4A to FIG. 4F are schematic diagrams of an execution flow according to an embodiment of the present invention.

FIG. 5 is a flowchart of virtual image selection according to an embodiment of the present invention.

FIG. 6 is a schematic diagram of scene image switching according to an embodiment of the present invention.

FIG. 7 is a flowchart of tracking according to an embodiment of the present invention.

FIG. 8 is a schematic diagram of content switching of a presentation according to an embodiment of the present invention.

FIG. 9 is a flow chart of determining the location of an area image according to an embodiment of the present invention.

FIG. 10 is a schematic diagram of an actual situation in an application scenario according to an embodiment of the present invention.

FIG. 11 is a schematic diagram of virtual-real integration according to an embodiment of the present invention.

FIG. 12 is a schematic diagram of a corresponding relationship between tags and scene images according to an embodiment of the present invention.

FIG. 13 is a schematic diagram of a remote image frame according to an embodiment of the present invention.

FIG. 14 is a schematic diagram of an actual situation in an application scenario according to an embodiment of the present invention.

FIG. 15 is a schematic diagram of a corresponding relationship between tags and area images according to an embodiment of the present invention.

FIG. 16 is a schematic diagram of virtual-real integration according to an embodiment of the present invention.

FIG. 17 is a schematic diagram of a remote image frame according to an embodiment of the present invention.

FIG. 18A is a schematic diagram of an actual situation in an application scenario according to an embodiment of the present invention.

FIG. 18B is a schematic diagram of a ring-shaped virtual image according to an embodiment of the present invention.

FIG. 18C is a schematic diagram of virtual-real integration according to an embodiment of the present invention.

FIG. 18D is a schematic diagram of the corresponding relationship between tags and scene images according to an embodiment of the present invention.

FIG. 18E is a schematic diagram of a ring-shaped scene image according to an embodiment of the present invention.

FIG. 18F is a schematic diagram of a remote image frame according to an embodiment of the present invention.

FIG. 19 is a flowchart of warning in an activity area range according to an embodiment of the invention.

FIG. 20 is a schematic diagram of warning in an activity area range according to an embodiment of the invention.

### DESCRIPTION OF THE EMBODIMENTS

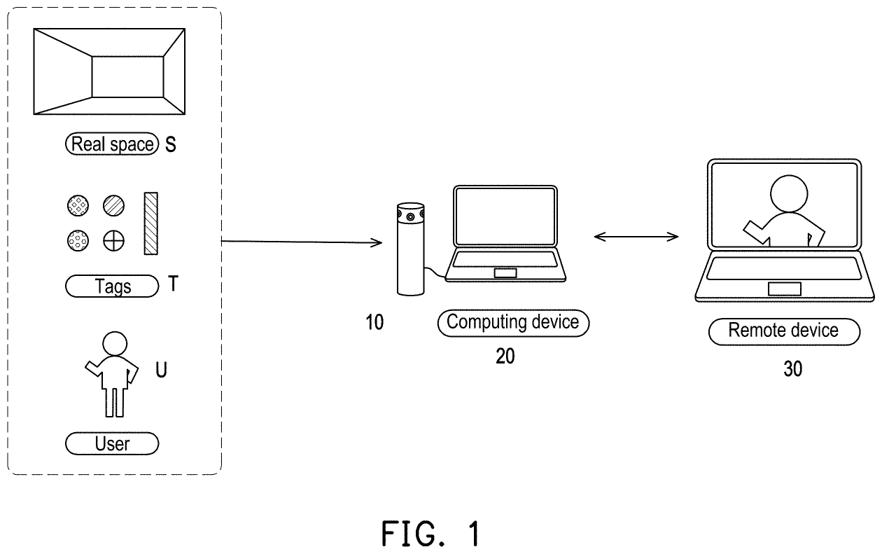

FIG. 1 is a schematic diagram of an image conference system 1 according to an embodiment of the present invention. Referring to FIG. 1, the image conference system 1 includes an image capture device 10, a computing device 20 and a remote device 30 (but is not limited to).

The image capture device 10 can be a monochrome camera or a color camera, a stereo camera, a digital camera, a depth camera or any other sensor capable of capturing images. The image capture device 10 can be a 360-degree camera, and can shoot objects or environments on three axes. However, the image capture device 10 may also be a fisheye camera, a wide-angle camera, or a camera with other fields of view. In an embodiment, the image capture device 10 is configured to capture an image.

In an embodiment, the image capture device 10 is installed in a real space S. One or more tags T and one or more users U exist in the real space S. And the image capture device 10 shoots the tags T and/or the users U.

The computing device 20 is coupled to the image capture device 10. The computing device 20 may be a smartphone, tablet, server, or other electronic device with computing capabilities. In an embodiment, the computing device 20 can receive images captured by the image capture device 10.

The remote device 30 may be a smart phone, a tablet computer, a server, or other electronic devices with computing functions. In an embodiment, the remote device 30 may be directly or indirectly connected to the computing device 20 and receive streaming images from the computing device 20. For example, the remote device 30 establishes a video call with the computing device 20.

In some embodiment, the computing device 20 or remote device 30 is further connected to display 70 (such as, Liquid-Crystal Display (LCD), Light-Emitting Diode (LED) display, Organic Light-Emitting Diode (OLED) display or other display) and used to play video. In an embodiment, the display is the display of the remote device 30 in a remote conference situation. In another embodiment, the display is the display of the computing device 20 in the remote conference situation.

Hereinafter, the method according to the embodiment of the present invention will be described in conjunction with various devices, components and modules in the image conference system 1. Each process of the method can be adjusted according to the implementation situation, and it is not limited thereto.

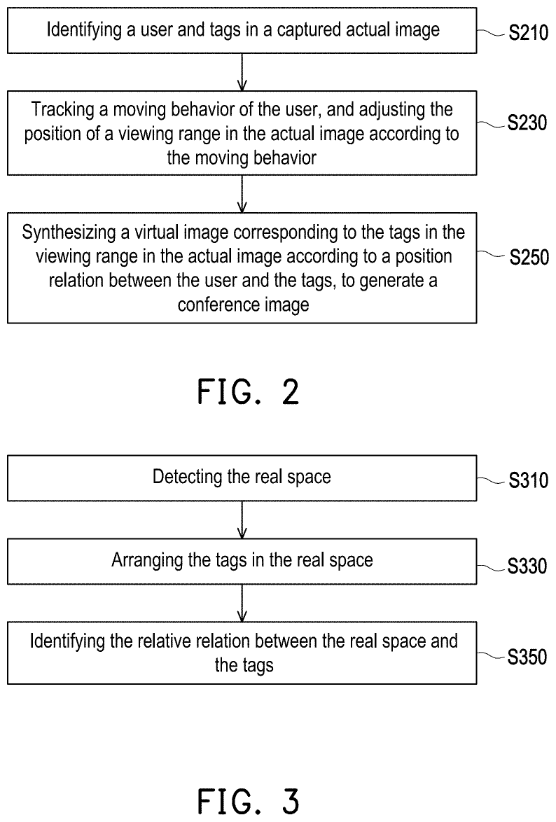

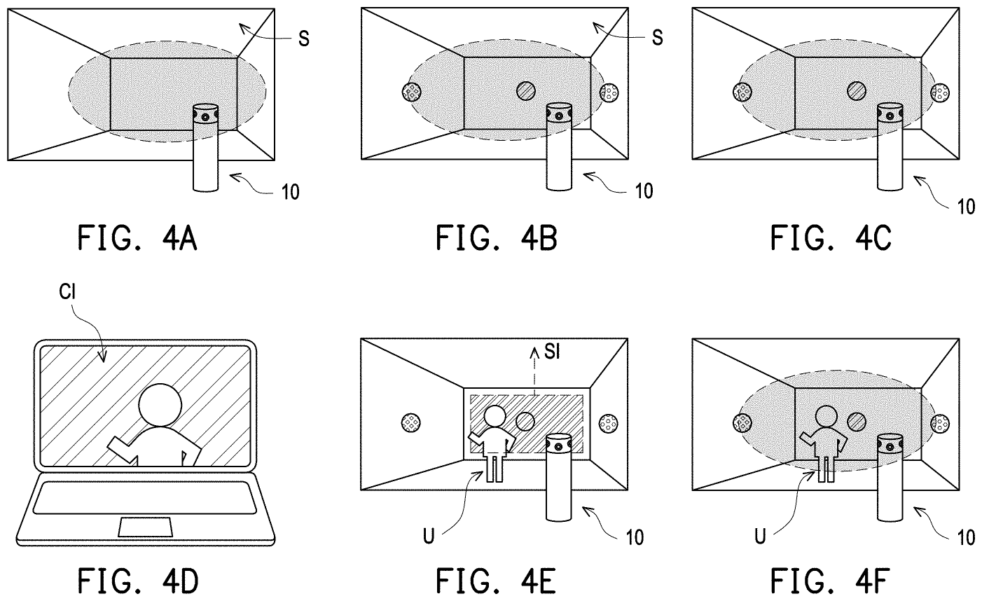

FIG. 2 is a flowchart of a generating method of a conference image according to an embodiment of the present invention. Referring to FIG. 2, the computing device 20 identify one or more users and one or more tags in an actual image captured by the image capture device 10 (Step S210). Specifically, FIG. 3 is a flowchart of identifying a position relation according to an embodiment of the present invention and FIG. 4A to FIG. 4F are schematic diagrams of an execution flow according to an embodiment of the present invention. Referring to FIG. 3 and FIG. 4A, the image capture device 10 is set in a real space S (such as, office, room, or conference room). The computing device 20 detects the real space S based on the actual image captured by the image capture device 10 (Step S310). For example, the computing device 20 detects the size of the real space S, walls, and objects (such as, tables, chairs, or computers) therein.

Referring to FIG. 3 and FIG. 4B, the tags T1, T2, T3 are arranged in the real space S (Step S330). The tags T1, T2, T3 may be various types of text, symbols, patterns, colors, or combinations thereof. The computing device 20 can realize object detection based on the algorithm of neural network (such as, YOLO, Convolutional Neural Network (R-CNN), or Fast Region Based CNN) or the algorithm based on feature comparison (such as, the feature comparison of Histogram of Oriented Gradient (HOG), Harr, or Speeded Up Robust Features (SURF)) and deduce the types of tags T1, T2, T3 accordingly. According to different requirements, the arranged tags T1, T2, T3 can be set on the wall, desktop or bookcase.

Then, referring to FIG. 3 and FIG. 4C, the computing device 20 detects the relative relation between the real space S and the tags T1, T2, T3 based on the actual image captured by the image capture device 10 again. Specifically, the computing device 20 can record in advance the sizes of the specific tags T1, T2, T3 (may be related to the length, width, radius, or area) at multiple different positions in the real space S, and associate these positions with the sizes in the actual image. Then, the computing device 20 can determine the coordinates of the tags T1, T2, and T3 in space according to the sizes of the tags T1, T2, and T3 in the actual image, and use them as position information.

Referring to FIG. 4D, when the user U enters the real space S, the computing device 20 recognizes the user U based on the actual image captured by the image capture device 10, and determines the relative relation between the user U and the tags T1, T2, and T3 in the real space S. Similarly, the computing device 20 can identify the user U through the aforementioned object detection technology. In addition, the computing device 20 can calculate the relative distance and direction of the user U and the tags T1, T2, T3 based on the length of the reference object (such as, eye width, head width, nose height) on the user U. And according to this, the relative relation between the user U and the tags T1, T2, T3 in the real space S is obtained. It should be noted that there are many other image-based ranging technologies, which are not limited in the embodiment of the present invention.

Referring to FIG. 2, the computing device 20 tracks the moving behavior of the user, and adjusts the position of the viewing range in the actual image according to the moving behavior (Step S230). Specifically, the computing device 20 can determine the user's moving behavior according to the user's location at different time points. The moving behavior is, for example, moving right, backward or forward, but not limited thereto. On the other hand, the actual images may be 360-degree images, wide-angle images, or images of other fields of view. The computing device 20 can crop a part of the area (that is, the viewing range) in the actual image, and provide the streaming images for output. In other words, what is displayed on the monitor is the image within the viewing range. The determination of the viewing range will refer to the user's position, and the position of the viewing range will be changed in response to the user's movement behavior. For example, the center of the viewing range is roughly aligned with the user's head or within 30 cm of the head.

Referring to FIG. 2, the computing device 20 synthesizes the virtual images corresponding to the one or more tags in the viewing range in the actual image according to the position relation between the user and the one or more tags to generate a conference image (Step S250). Specifically, the tags are used to locate virtual images. Different types of tags may correspond to different virtual images. When the user approaches the specific tag, the user wants to introduce the virtual image corresponding to the approached tag to the viewer, and the computing device 20 can automatically synthesize the virtual image and the actual image to form the conference image. The position relation can be relative distance and/or direction.

The virtual image may be a scene image or an area image. The scene image can cover all or part of the viewing range. The area image only covers part of the viewing range. In addition, the extent of the area image is usually smaller than the scene image. The content of the virtual image can be animation, picture or video, and it can also be the content of the presentation, but it is not limited to this.

Referring to FIG. 4E, the range of the virtual image SI roughly corresponds to the wall behind the user U. In an embodiment, the computing device 20 may remove the non-user area in the viewing range of the actual image, and fill the scene image in the removed area. That is, image de-backing technique. The computing device 20 first recognizes the image of user based on the object detection technology, so as to remove the part of the actual image that does not belong to the user, and directly replace the removed part with the virtual image. For example, referring FIG. 4F, the display may combine the virtual image SI with the conference image CI of the user U.

There may be many different tags in the real space S, so it is necessary to select an appropriate virtual image according to the position relation. In an embodiment, the position relation between the user and the tags is the distance between the user and the tags. The computing device 20 can determine the distance between the user and the tags is less than an activation threshold (such as, 10, 30, or 50 cm), and the corresponding virtual image is selected according to the determined result that the distance is less than the activation threshold. That is to say, the computing device 20 only selects the virtual images of the tags that are within a certain distance from the user, but does not select the virtual images of the tags that are beyond the distance.

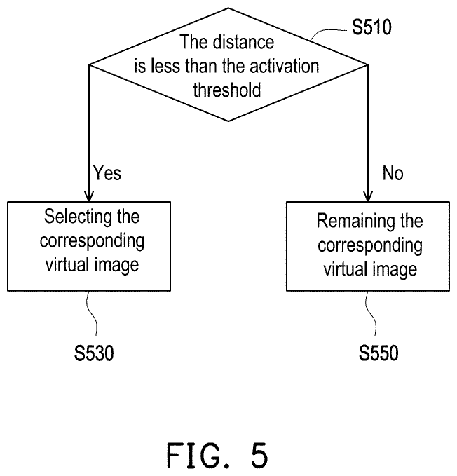

FIG. 5 is a flowchart of virtual image selection according to an embodiment of the present invention. Referring to FIG. 5, the computing device 20 determines whether the distance between the user and the tags in the actual image is less than the activation threshold (Step S510). If the distance is less than the activation threshold (that is, Yes), the computing device 20 selects the virtual image corresponding to the tags (Step S530). It is worth noting that if the tag is different from the tag corresponding to the current virtual image, the computing device 20 can replace the original virtual image in the conference image with a new virtual image. That is, to achieve image switching. If the distance is not less than the activation threshold (that is, No), the computing device 20 remains the virtual image corresponding to the original tags (Step S550).

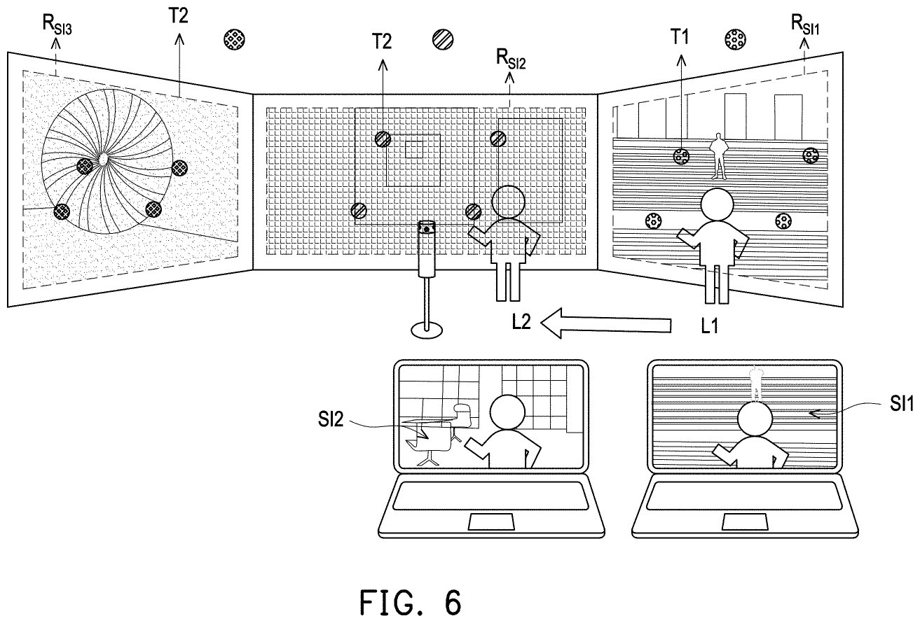

Described in an application scenario, FIG. 6 is a schematic diagram of scene image switching according to an embodiment of the present invention. Referring to FIG. 6, the tags T1, T2, and T3 are respectively set with their own scene boundary ranges RSI1, RSI2, and RSI3. When the presenter is at the position L1, the presenter is located within the scene boundary range RSI1, so the virtual image SI1 in the conference image corresponds to the tag T1. When the presenter moves to the position L2, the computing device 20 detects that the presenter enters the scene boundary range RSI2, so the computing device 20 switches the virtual image SI1 to the virtual image SI2 corresponding to the tag T2.

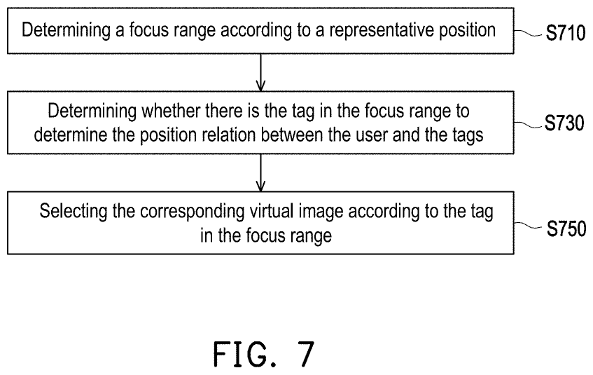

FIG. 7 is a flowchart of tracking according to an embodiment of the present invention. Referring to FIG. 7, the computing device 20 may determine the focus range according to the representative position of the user in the actual image (Step S710). For example, the representative position is the position of the user's nose, eyes or mouth. The focus range can be a circle, a rectangle or other shapes centered on the representative position. The computing device 20 can determine whether there is a tag in the focus range, so as to determine the position relation between the user and the tag (step S730). For example, if the tag is within the focus range, it means that the user is approaching the tag; otherwise, it means that the user is far away from the tag. In addition, the position relation may also be defined by the actual distance and/or direction, but is not limited thereto. The computing device 20 may select the corresponding virtual image according to the tag in the focus range (step S750). That is, the computing device 20 selects only the virtual images of the tags within the focus range, but does not select the virtual images of the tags that are out of the focus range. The computing device 20 can select the virtual image according to the position of the tag in the focus range.

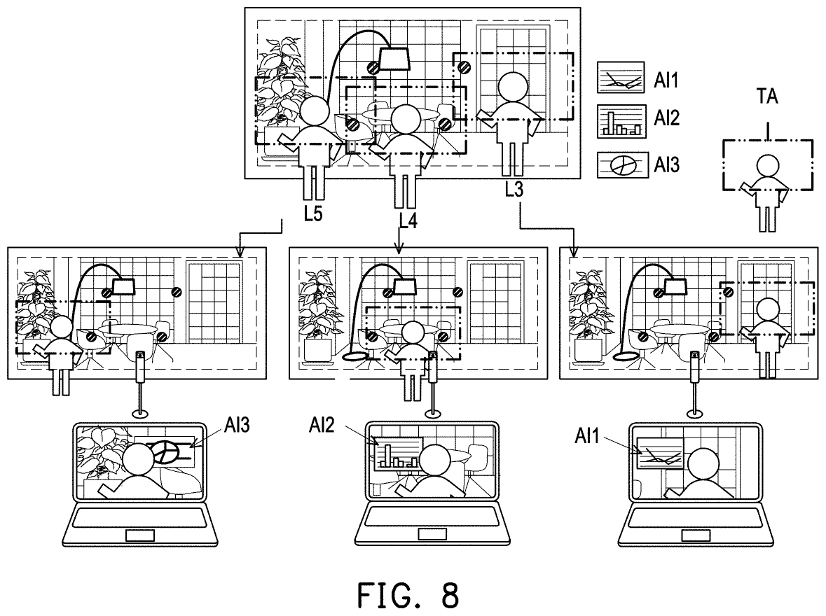

For example, FIG. 8 is a schematic diagram of content switching of a presentation according to an embodiment of the present invention. Referring to FIG. 8, the focus range TA is a rectangle centered on the face of the presenter. The focus range TA is a rectangle centered on the face of the presenter. The contents of the area images are the presentation contents AI1, AI2, and AI3. When the computing device 20 detects that one or two tags are located on the left side of the presenter, for example, the presenter is located at the position L3, the synthesis of the presentation content AI1 is started. When the computing device 20 detects that there are tags on the left and right sides of the presenter, for example, the presenter is located at the position L4, the synthesis of the presentation content AI2 is started. When the computing device 20 detects that the tag object is located on the right side of the presenter, for example, the presenter is located at the position L4, the synthesis of the presentation content AI3 is started. The synthesis of the aforementioned presentation content may be an image in which the presenter is in front and the presentation content is behind.

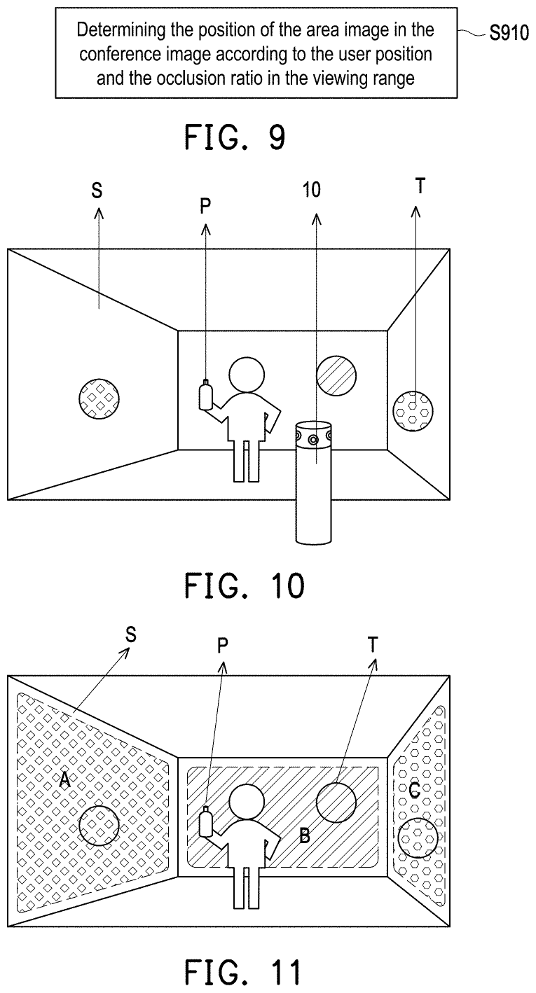

In order to avoid excessive occlusion of the area image (such as, presentation content) by the user, the location of the area image can be dynamically adjusted. FIG. 9 is a flow chart of determining the location of an area image according to an embodiment of the present invention. Referring to FIG. 9, the computing device 20 may determine the position of the area image in the conference image according to the user's position in the viewing range and the occlusion ratio (Step S910). The occlusion ratio is related to the ratio at which the user is allowed to occlude the area image. For example, 30, 40 or 50%. Alternatively, the user is in the center of the area image. In addition, the computing device 20 can also adjust the position of the area image in the conference image according to the user's activity area range. For example, place presentation content at the edge of the activity area range.

Three application scenarios will be described below. Application scenarios for panorama mode. FIG. 10 is a schematic diagram of an actual situation in an application scenario according to an embodiment of the present invention. Referring to FIG. 10, the user is located in the real space S and holds the product P in hand. The image capture device 10 captures the real space S. The real wall can be clearly defined in the real space S, and a tag T with a different pattern is arranged on each wall.

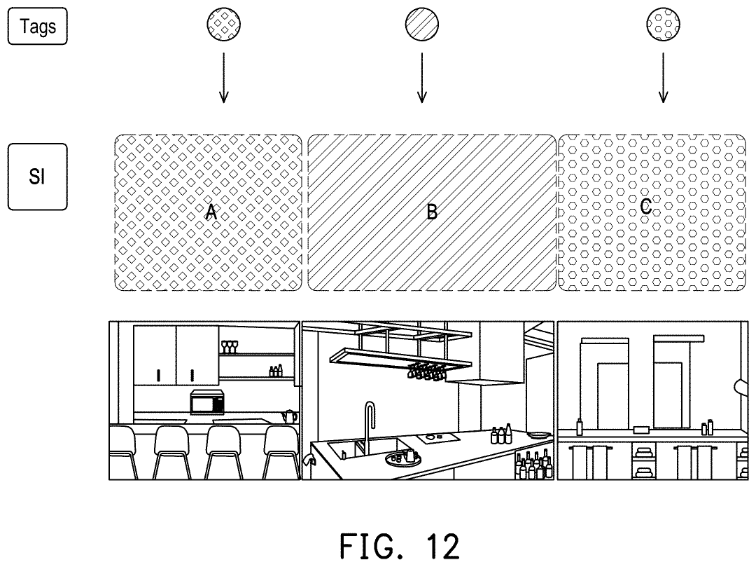

FIG. 11 is a schematic diagram of virtual-real integration according to an embodiment of the present invention, and FIG. 12 is a schematic diagram of a corresponding relationship between tags and scene images according to an embodiment of the present invention. Referring to FIG. 11 and FIG. 12, each tag T is respectively defined with different virtual images SI (such as, scene image A, scene image B, and scene image C), and the virtual images SI will cover the entire wall. In a default state, the computing device 20 detects the tag T through the image capture device 10, and can provide panoramic virtual image synthesis. In addition, the presenter can cancel the corresponding virtual image by occluding the tag.

For example, scene image A, scene image B, and scene image C correspond to the kitchen, living room, and bathroom, respectively. When introducing the product, the presenter can walk freely in the space with the product P in hand, and describe the corresponding function and practical situation of the product in the corresponding scene.

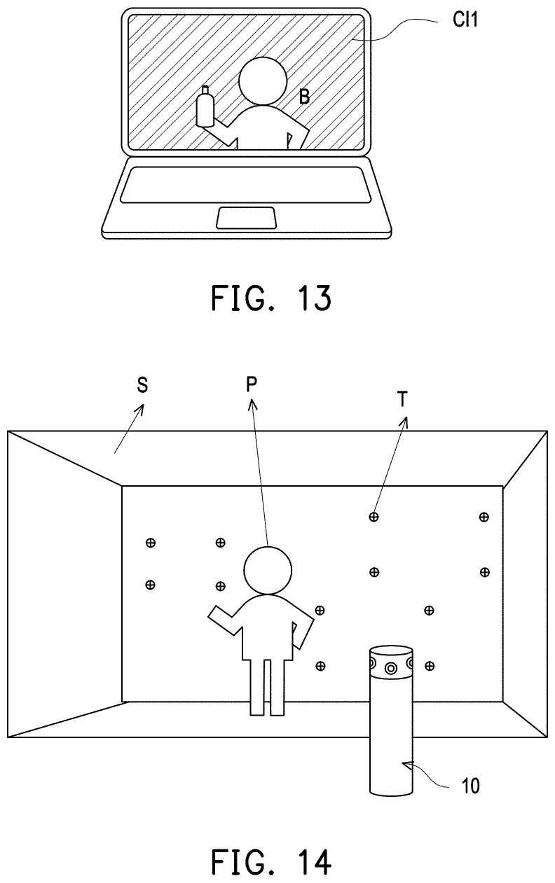

FIG. 13 is a schematic diagram of a remote image frame according to an embodiment of the present invention. Referring to FIG. 13, the conference image CI1 is a synthesized image of the presenter and the scene image B, and can be used as an image displayed on the display of the remote device 30.

Application scenarios for local mode. FIG. 14 is a schematic diagram of an actual situation in an application scenario according to an embodiment of the present invention. Referring to FIG. 14, the user is in the real space S and holds the product P. The image capture device 10 shoots the real space S. The real wall can be clearly defined in the real space S, and a plurality of tags T are arranged on one wall.

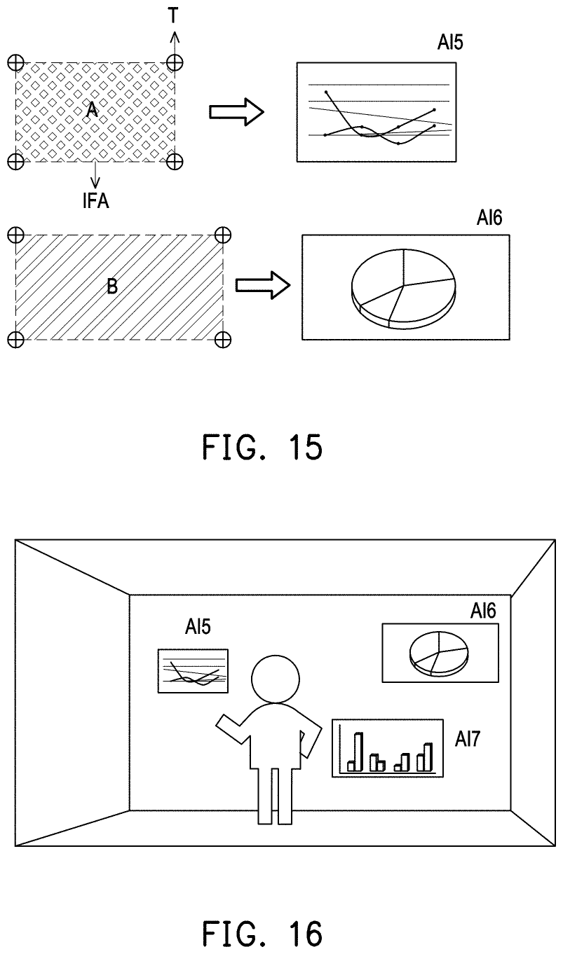

In an embodiment, the computing device presents the area image in the imaging range surrounded by those tags. That is to say, the area image is presented in the imaging range in the conference image, and this imaging range is formed by connecting multiple tags. For example, FIG. 15 is a schematic diagram of a corresponding relationship between tags T and area images according to an embodiment of the present invention. Referring to FIG. 15, the four tags T define the imaging range A and the imaging range B according to different arrangement positions, and are used for the presentation contents AI5 and AI6 respectively.

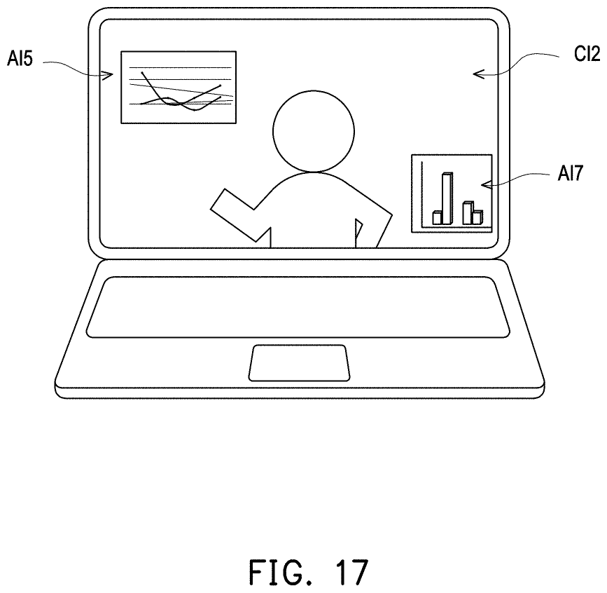

FIG. 16 is a schematic diagram of virtual-real integration according to an embodiment of the present invention. Referring to FIG. 16, in the default state, when the computing device 20 detects the tag T through the image capture device 10, and it can provide the synthesis of the area-based virtual image. FIG. 17 is a schematic diagram of a remote image frame according to an embodiment of the present invention. Referring to FIG. 17, the conference image CI2 includes presentation contents AI5 and AI7, and can be used as a picture presented on the display of the remote device 30.

For example, the presentation contents AI5, AI6, and AI7 correspond to a line graph, a pie graph, and a bar graph, respectively. If multiple charts, images, etc. are needed to assist in the presentation, the presenter can synthesize various charts, images, etc. into the real space S as virtual images.

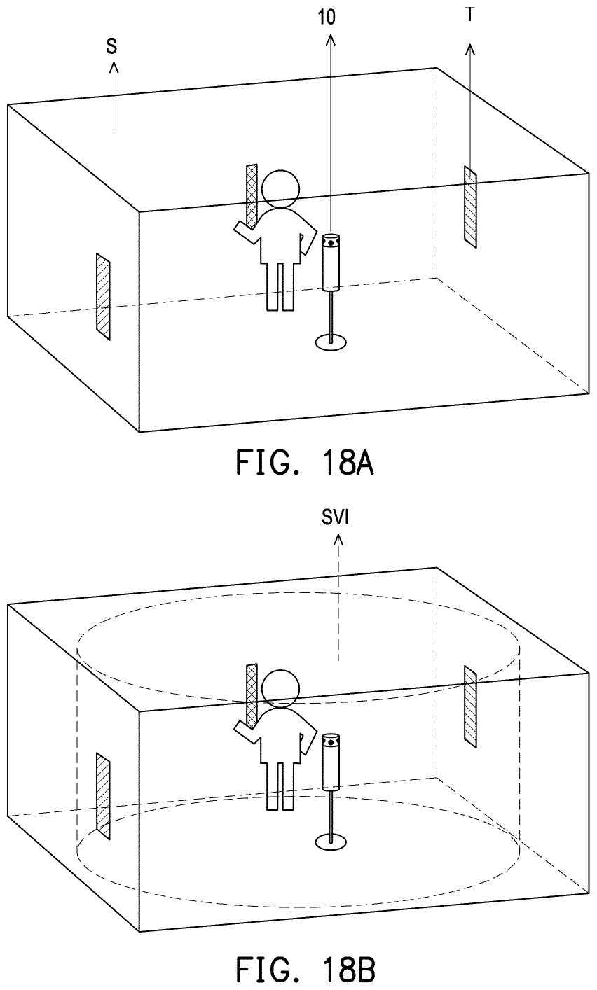

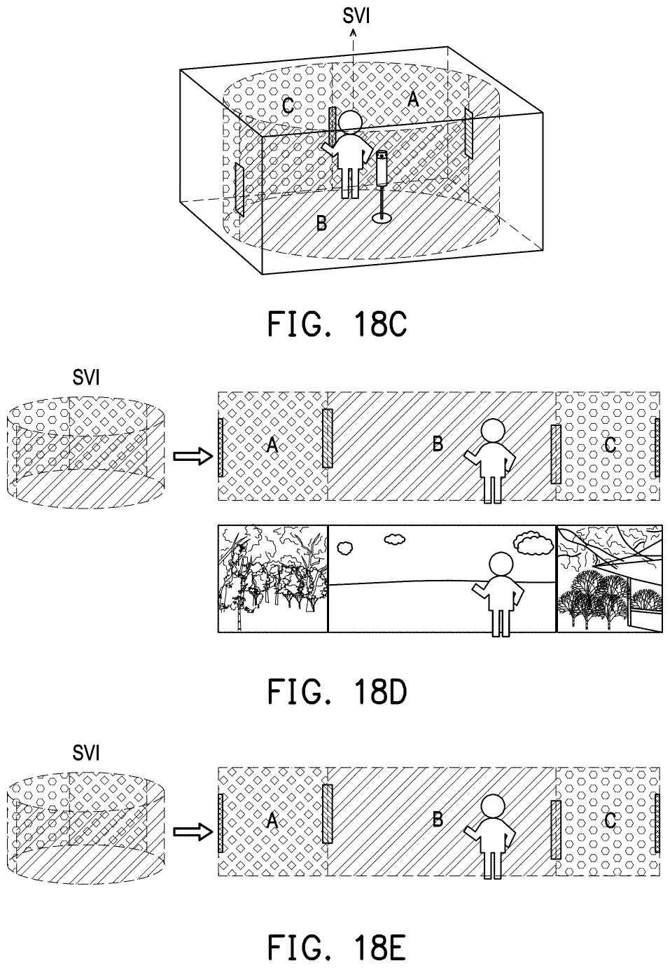

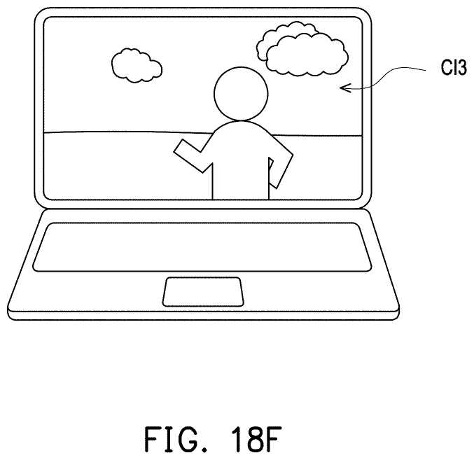

Application Scenario for Ring Mode. FIG. 18A is a schematic diagram of an actual situation in an application scenario according to an embodiment of the present invention. Referring to FIG. 18A, the image capture device 10 is a 360-degree camera, and can be stitched into a ring (long banner) image. FIG. 18B is a schematic diagram of a ring-shaped virtual image SVI according to an embodiment of the present invention.

The tags T are arranged in the real space S. Each tags T is used to divide the ring-shaped virtual image SVI into regions, and the corresponding virtual images are synthesized by the computing device 20 respectively. FIG. 18C is a schematic diagram of virtual-real integration according to an embodiment of the present invention, and FIG. 18D is a schematic diagram of the corresponding relationship between tags and scene images according to an embodiment of the present invention. Referring to FIG. 18C and FIG. 18D, scene image A, scene image B, and scene image C correspond to autumn maple red, summer seascape, and spring cherry blossom viewing, respectively.

FIG. 18E is a schematic diagram of a ring-shaped scene image according to an embodiment of the present invention. Referring to FIG. 18E, the tags T are set between scene image A and scene image B and between scene image B and scene image C. When the presenter moves freely in the space, he can know the switching boundary of each virtual image through the tags, which is helpful for the presentation. FIG. 18F is a schematic diagram of a remote image frame according to an embodiment of the present invention. Referring to FIG. 18F, the conference image CI3 includes the scene image B, and can be used as a picture presented on the display of the remote device 30. In this way, presenters can introduce different views as they walk, making the experience livelier and more natural.

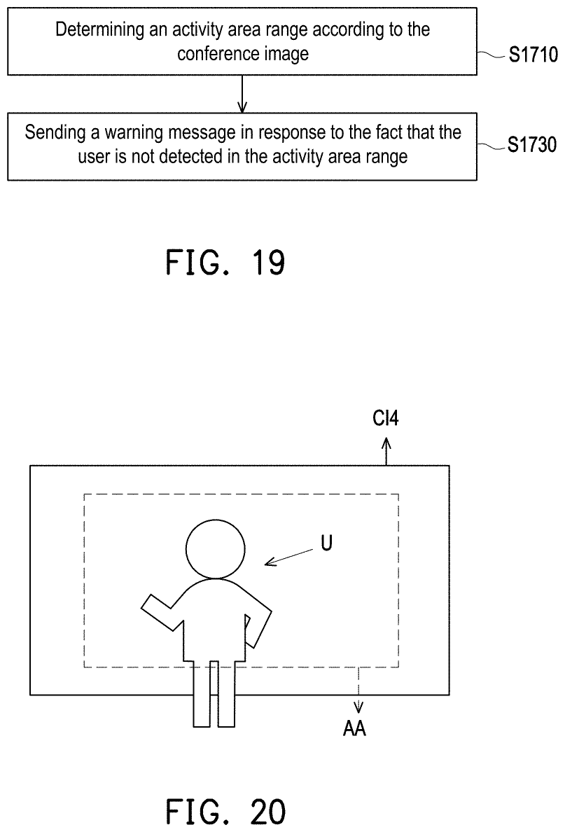

In order to allow the user to continuously appear in the conference image, FIG. 19 is a flowchart of warning in an activity area range according to an embodiment of the invention. Referring to FIG. 19, the computing device 20 may determine an activity area range in the conference image according to the conference image (Step S1710). For example, FIG. 20 is a schematic diagram of warning in an activity area range according to an embodiment of the invention. Referring FIG. 20, the activity area range AA is defined within the viewing range of the conference image CI4. This viewing range may have an area proportional relationship or other position relation with the activity area range AA. Referring to FIG. 19 and FIG. 20, if the user U is not detected in the activity area range AA, the computing device 20 may sending a warning message (Step S1730). The warning message may be a text message, alert or video message.

To sum up, in the image conference system and the generating method of conference images according to the embodiments of the present invention, the virtual images are defined according to the tags, and the virtual images and the actual images are dynamically synthesized according to the user's position. In this way, the state of the virtual image can be changed by interacting with the tags, thereby improving the operation and viewing experience.

Although the present application has been disclosed as above with embodiments, it is not intended to limit the present application, any person with ordinary knowledge in the technical field, without departing from the spirit and scope of the present application, can make some changes. Therefore, the protection scope of the present application shall be determined by the scope of the claims.

What is claimed is:

1. An image conference system, comprising:
an image capture device, configured to capture an image; and
a computing device, coupled to the image capture device and configured to:
identify a user and at least one tags in an actual image captured by the image capture device;
track a moving behavior of the user, and adjust the position of a viewing range in the actual image according to the moving behavior; and
synthesize a virtual image corresponding to the at least one tags in the viewing range in the actual image according to a position relation between the user and the at least one tags, to generate a conference image.

2. The image conference system according to claim 1, wherein the computing device is further configured to:
determine a focus range according to a representative position of the user in the actual image;
determine whether there is the tag in the focus range to determine the position relation between the user and the at least one tags; and
select the corresponding virtual image according to the tag in the focus range.

3. The image conference system according to claim 1, wherein the position relation between the user and the at least one tags comprises a distance between the user and the at least one tags, and the computing device is further configured to:
determine the distance is less than an activation threshold; and
select the corresponding virtual image according to a determining result that the distance is less than the activation threshold.

4. The image conference system according to claim 1, wherein the computing device is further configured to:
replace an original virtual image in the conference image with a new virtual image.

5. The image conference system according to claim 1, wherein the virtual image is a scene image, and the computing device is further configured to:
remove an area not for the user in the viewing range of the actual image; and
fill the scene image in the removed area.

6. The image conference system according to claim 1, wherein the virtual image is an area image, the area image is smaller than the viewing range, and the computing device is further configured to:
determine a position of the area image in the conference image according to a user position and an occlusion ratio of the user in the viewing range, wherein the occlusion ratio is related to the ratio at which the user is allowed to occlude the area image.

7. The image conference system according to claim 1, wherein the virtual image is an area image, the area image is smaller than the viewing range, the at least one tags comprises multiple tags, and the computing device is further configured to:
present the area image in an imaging range surrounded by the tags.

8. The image conference system according to claim 1, wherein the computing device is further configured to:
determine an activity area range in the conference image according to the conference image; and
send a warning message in response to the fact that the user is not detected in the activity area range.

9. A generating method of a conference image, comprising:
identifying a user and at least one tags in a captured actual image;
tracking a moving behavior of the user, and adjusting a position of a viewing range in the actual image according to the moving behavior; and
synthesizing a virtual image corresponding to the at least one tags in the viewing range in the actual image according to a position relation between the user and the at least one tags, to generate a conference image.

10. The generating method of the conference image according to claim 9, wherein the step of generating the conference image comprises:
determining a focus range according to a representative position of the user in the actual image;
determining whether there is the tag in the focus range to determine the position relation between the user and the at least one tags; and
selecting the corresponding virtual image according to the tag in the focus range.

11. The generating method of the conference image according to claim 9, wherein the position relation between the user and the at least one tags comprises a distance between the user and the at least one tags, and the step of generating the conference image comprises:
determining the distance is less than an activation threshold; and
selecting the corresponding virtual image according to a determining result that the distance is less than the activation threshold.

12. The generating method of the conference image according to claim 9, wherein the step of generating the conference image comprises:
replacing an original virtual image in the conference image with a new virtual image.

13. The generating method of the conference image according to claim 9, wherein the virtual image is a scene image, and the step of generating the conference image comprises:
removing an area not for the user in the viewing range of the actual image; and
filling the scene image in the removed area.

14. The generating method of the conference image according to claim 9, wherein the virtual image is an area image, the area image is smaller than the viewing range, and the step of generating the conference image comprises:
determining a position of the area image in the conference image according to a user position and an occlusion ratio of the user in the viewing range, wherein the occlusion ratio is related to the ratio at which the user is allowed to occlude the area image.

15. The generating method of the conference image according to claim 9, wherein the virtual image is an area image, the area image is smaller than the viewing range, the at least one tags comprises multiple tags, and the step of generating the conference image comprises:
presenting the area image in an imaging range surrounded by the tags.

16. The generating method of the conference image according to claim 9, wherein the step of generating the conference image comprises:
determining an activity area range in the conference image according to the conference image; and
sending a warning message in response to the fact that the user is not detected in the activity area range.
